(19) United States
(12) Patent Application Publication
(10) Pub. No.: US 2020/0166024 A1
(43) Pub. Date: May 28, 2020

(54) SMA ACTUATOR WITH POSITION SENSORS

(71) Applicant: CAMBRIDGE MECHATRONICS LIMITED, Cambridge, Cambridgeshire (GB)

(72) Inventors: Dominic George Webber, Cambridge (GB); James Howarth, Cambridge (GB); Andrew Benjamin Simpson Brown, Cambridge (GB); David Charles William Richards, Cambridge (GB); Andreas Flouris, Cambridge (GB)

(21) Appl. No.: 16/611,088

(22) PCT Filed: May 3, 2018
(86) PCT No.: PCT/EP2018/061440

§ 371 Date: Nov. 5, 2019

(30) Foreign Application Priority Data
May 5, 2017 (GB) 1707233.1

(51) Int. Cl. F03G 7/06; G03B 13/36; G03B 5/04

(52) U.S. Cl. CPC F03G 7/065; G03B 13/36; G03B 2205/0015; G03B 2205/0076; G03B 5/04

(57) ABSTRACT

Broadly speaking, embodiments of the present techniques provide apparatuses and methods for controlling the position and/or orientation of a moveable component of an actuator, using at least two shape memory alloy (SMA) actuator wires and at least one sensor for sensing position/orientation of the moveable component.

The present application generally relates to apparatus and methods for controlling the position and/or orientation of an actuator, and in particular for controlling the position and/or orientation of an actuator comprising a plurality of shape memory alloy (SMA) actuator wires.

In a first approach of the present techniques, there is provided an actuator comprising: a moveable component and a static component, where the moveable component is moveable relative to the static component; a first shape memory alloy (SMA) actuator wire having a first portion coupled to the moveable component and a second portion coupled to the static component, wherein contraction of the first SMA actuator wire causes the moveable component to move; a second shape memory alloy (SMA) actuator wire having a first portion coupled to the moveable component and a second portion coupled to the static component, wherein contraction of the second SMA actuator wire causes the moveable component to move, and wherein contraction of the first SMA actuator wire causes expansion of the second SMA actuator wire and contraction of the second SMA actuator wire causes expansion of the first SMA actuator wire; and at least one sensor for sensing a position or orientation of the moveable component relative to the static component

In a second approach of the present techniques, there is provided an apparatus comprising: an actuator for moving a component of the apparatus, the actuator comprising: a moveable component and a static component, where the moveable component is moveable relative to the static component; a first shape memory alloy (SMA) actuator wire having a first portion coupled to the moveable component and a second portion coupled to the static component, wherein contraction of the first SMA actuator wire causes the moveable component to move; a second shape memory alloy (SMA) actuator wire having a first portion coupled to the moveable component and a second portion coupled to the static component, wherein contraction of the second SMA actuator wire causes the moveable component to move, and wherein contraction of the first SMA actuator wire causes expansion of the second SMA actuator wire and contraction of the second SMA actuator wire causes expansion of the first SMA actuator wire; and at least one sensor for sensing a position or orientation of the moveable component relative to the static component.

In a third approach of the present techniques, there is provided a method for controlling an actuator, the method comprising: receiving a required position for a moveable component of the actuator, where the moveable component is moveable relative to a static portion of the actuator by a first shape memory alloy (SMA) actuator wire and by a second shape memory alloy (SMA) actuator wire, wherein contraction of the first SMA actuator wire causes the moveable component to move and expansion of the second SMA actuator wire, and wherein contraction of the second SMA actuator wire causes the moveable component to move and expansion of the first SMA actuator wire; receiving data from at least one sensor for sensing a current position of the moveable component relative to the static component; and generating control signals to control power delivered to the first SMA actuator wire and the second SMA actuator wire based on the sensor data, to adjust the position of the moveable component relative to the static component.

In a fourth approach of the present techniques, there is provided circuitry for controlling an actuator, the circuitry comprising: an interface for receiving a required position for a moveable component of the actuator, where the moveable component is moveable relative to a static portion of the actuator by a first shape memory alloy (SMA) actuator wire and by a second shape memory alloy (SMA) actuator wire, wherein contraction of the first SMA actuator wire causes the moveable component to move and expansion of the second SMA actuator wire, and wherein contraction of the second SMA actuator wire causes the moveable component to move and expansion of the first SMA actuator wire; where the circuitry: receives data from at least one sensor for sensing a current position of the moveable component relative to the static component; and generates control signals to control power delivered to the first SMA actuator wire and the second SMA actuator wire based on the sensor data, to adjust the position of the moveable component relative to the static component.

The present techniques also provide a non-transitory data carrier carrying processor control code to implement any of the methods or processes described herein.

Preferred features are set out in the appended dependent claims.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog® or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

Implementations of the present techniques will now be described, by way of example only, with reference to the accompanying drawings, in which:

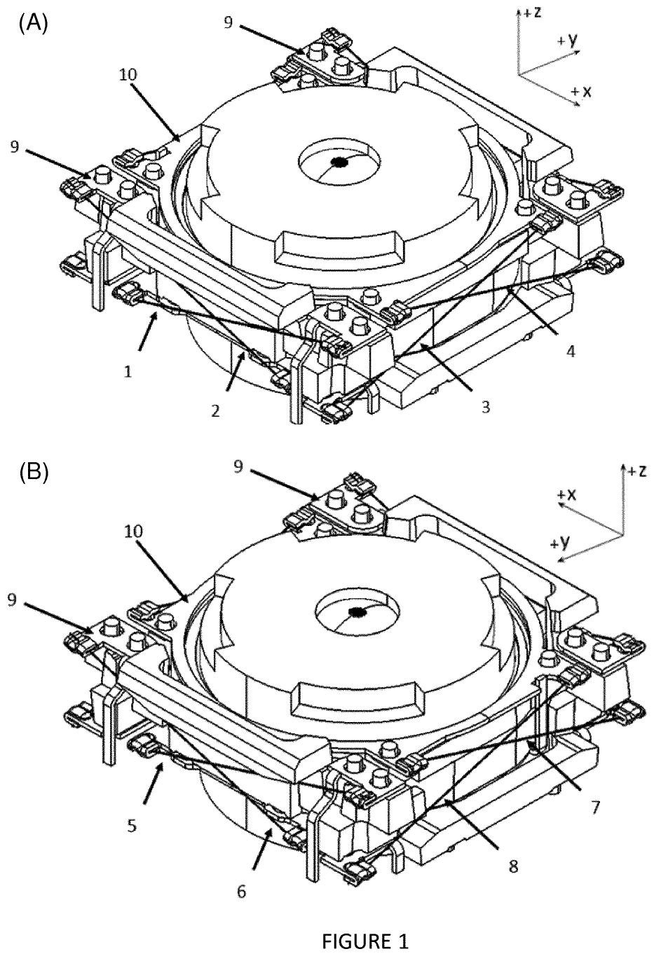

FIG. 1A shows a perspective view of two sides of a device comprising an actuator, and FIG. 1B shows a perspective view of two other sides of the device;

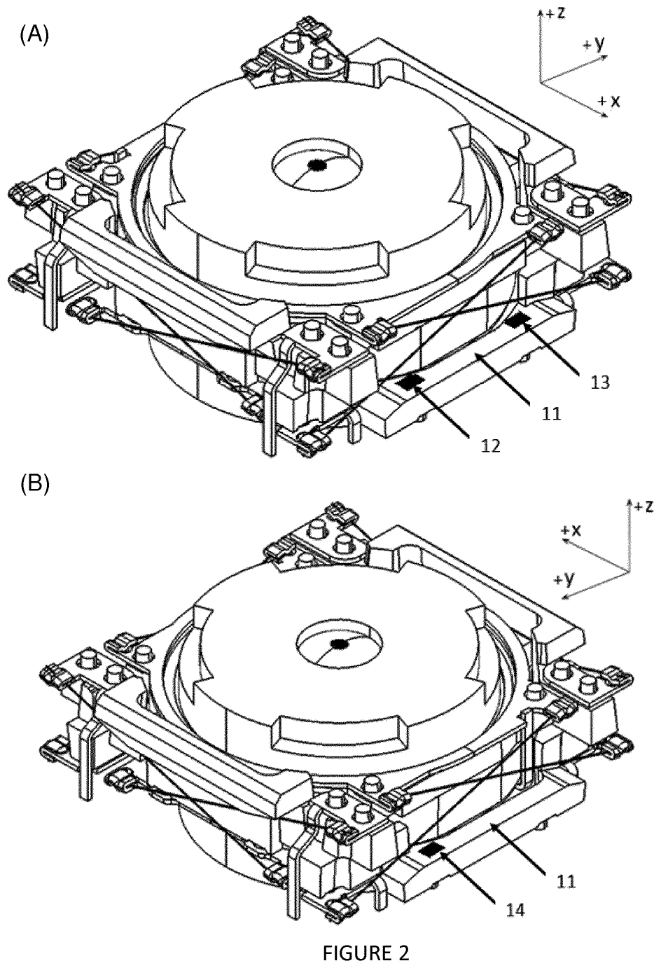

FIG. 2A is a perspective view of the device of FIG. 1A showing the position of a first and a second Hall effect sensor, and FIG. 2B is a perspective view of the device of FIG. 1B showing the position of a third Hall effect sensor;

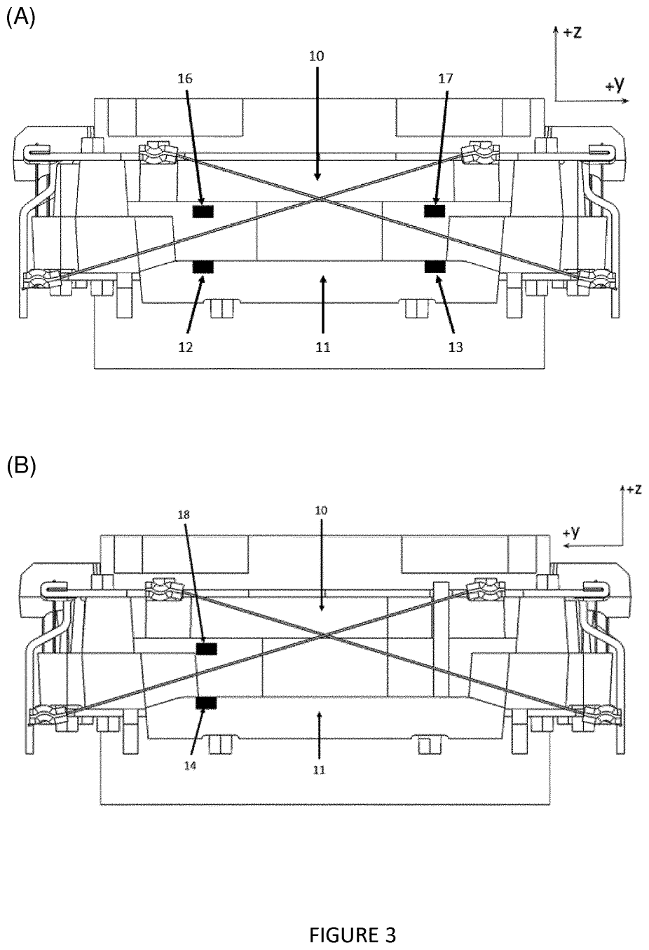

FIG. 3A is a side view of the device of FIG. 1A showing the position of a first and a second Hall effect sensor and a first and a second magnet, and FIG. 3B is a side view of the device of FIG. 1B showing the position of a third Hall effect sensor and a third magnet;

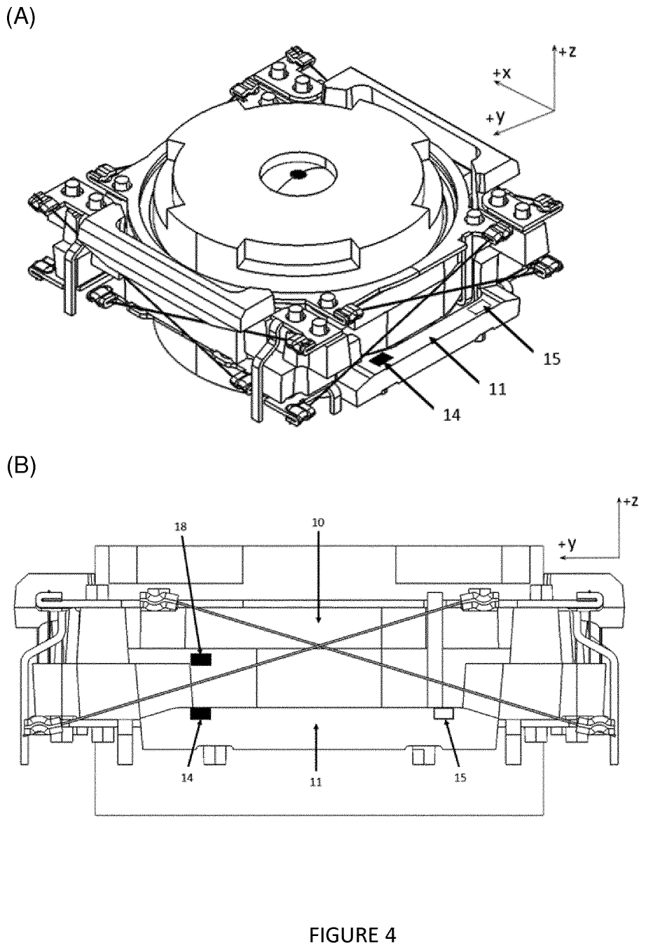

FIG. 4A is a perspective view of the device of FIG. 1B showing the position of a third and a fourth Hall effect sensor, and FIG. 4B is a side view of the device of FIG. 4A showing the position of a third and a fourth Hall effect sensor and a third magnet;

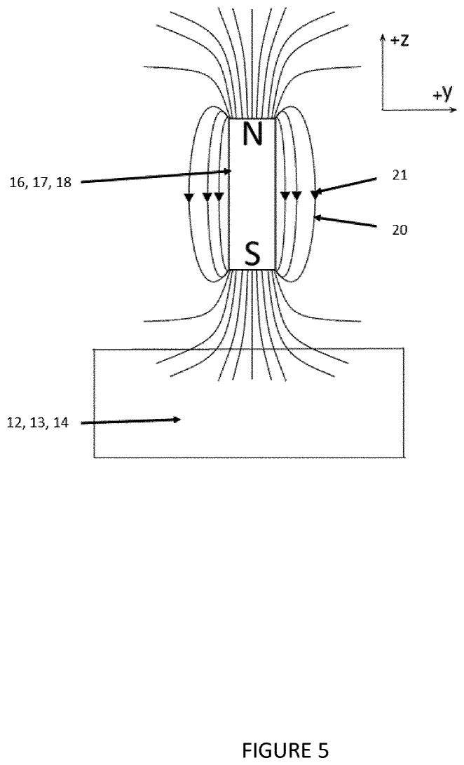

FIG. 5 is a schematic diagram of an example arrangement of magnets relative to Hall effect sensors;

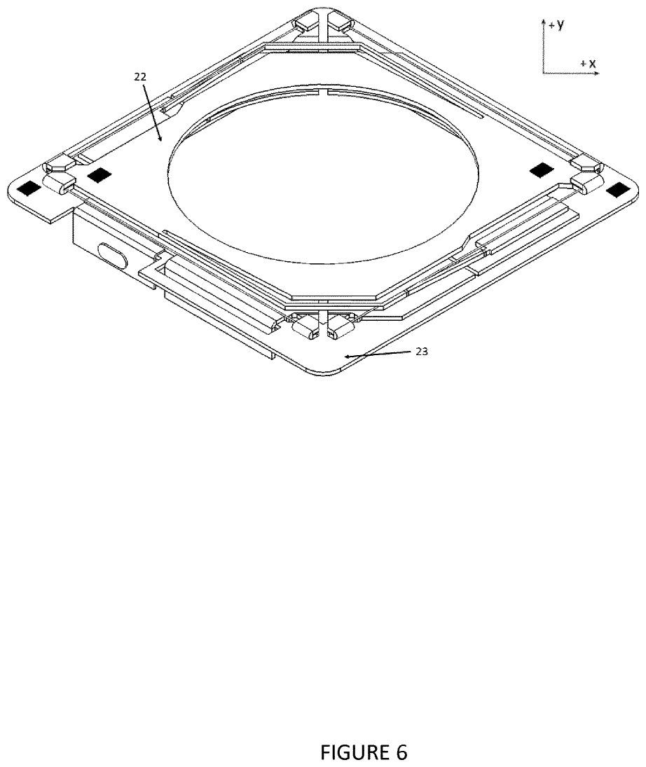

FIG. 6 is a perspective view of an device comprising an optical image stabilisation (OIS) actuator;

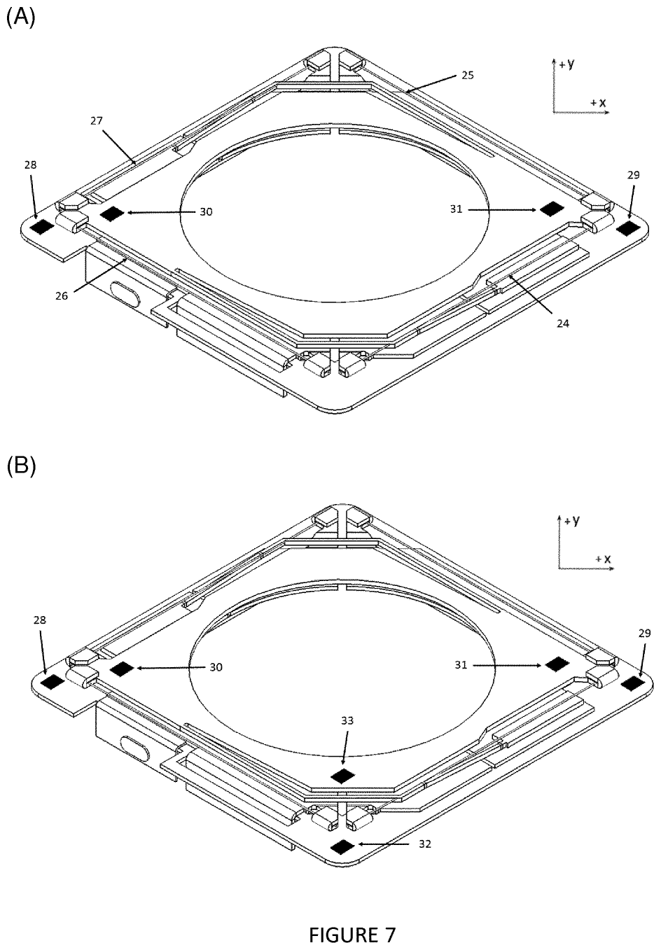

FIG. 7A is a perspective view of the device of FIG. 6 showing an example arrangement of Hall effect sensors and magnets;

FIG. 7B is a perspective view of the device of FIG. 6 showing another example arrangement of Hall effect sensors and magnets;

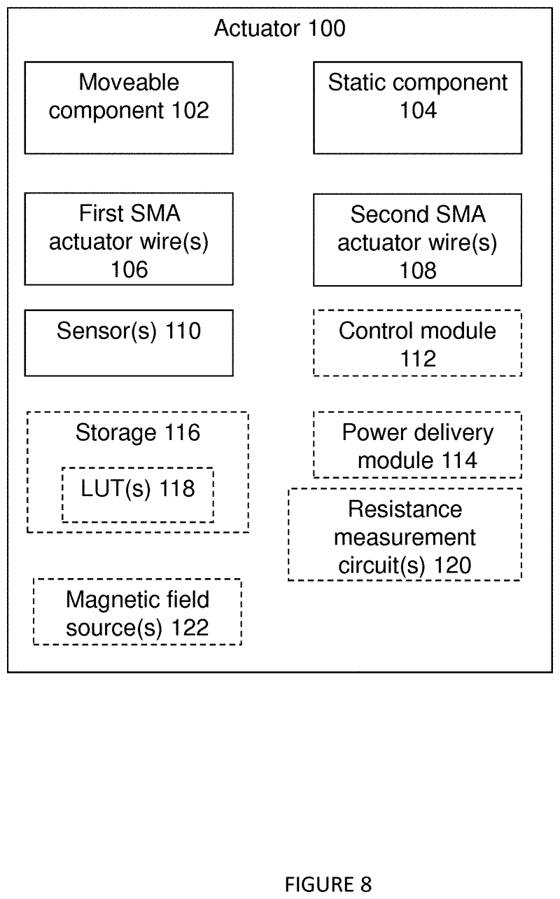

FIG. 8 shows a schematic block diagram of an actuator having a moveable component;

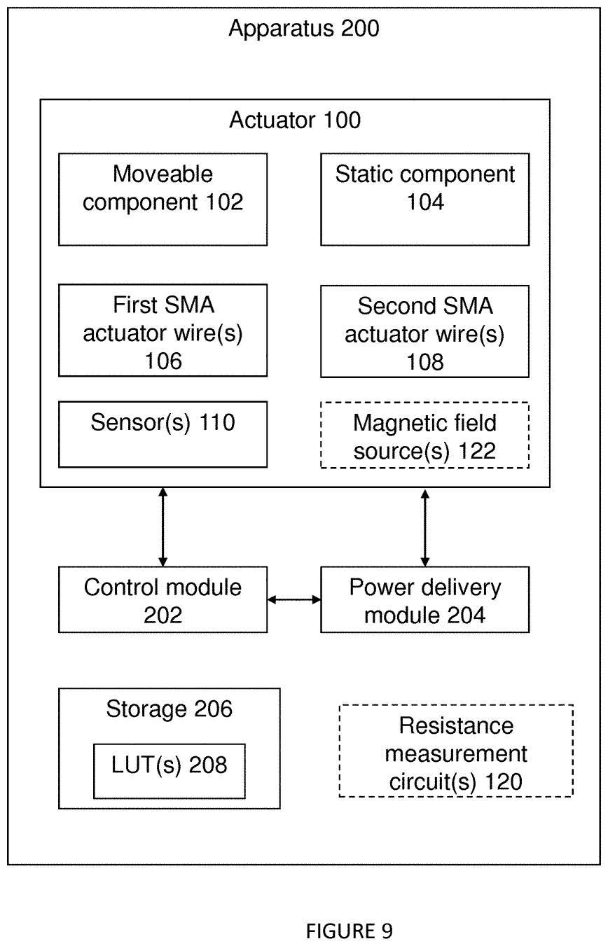

FIG. 9 shows a schematic block diagram of an apparatus comprising an actuator;

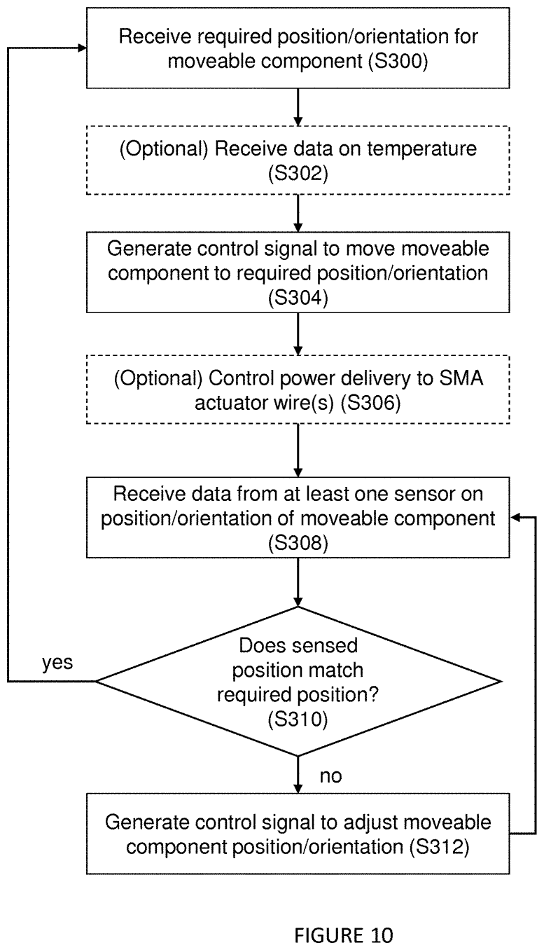

FIG. 10 shows a flowchart of example steps to control position and/or orientation of a moveable component of an actuator; and

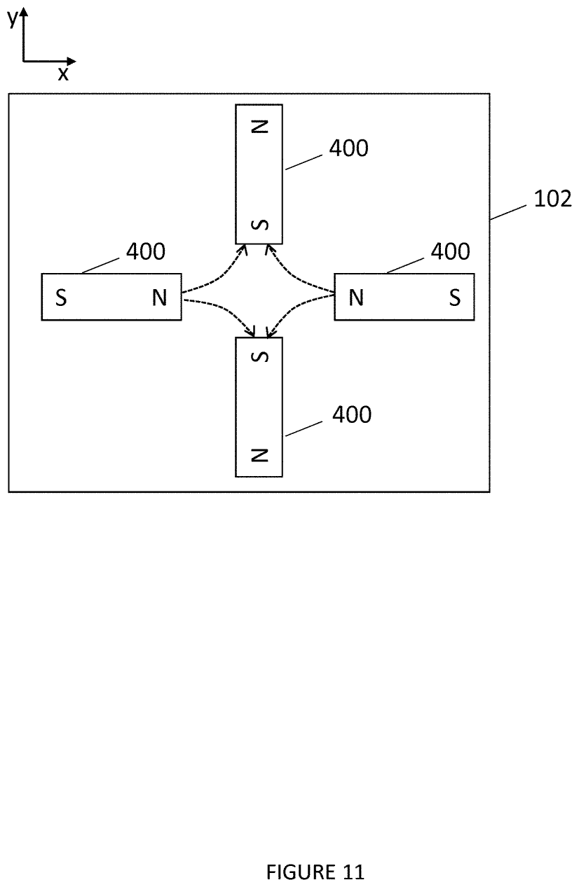

FIG. 11 is a schematic diagram of a quadrupole magnet.

Broadly speaking, embodiments of the present techniques provide apparatuses and methods for controlling the position and/or orientation of a moveable component of an actuator using at least two shape memory alloy (SMA) actuator wires, using at least two shape memory alloy (SMA) actuator wires and at least one sensor for sensing position/orientation of the moveable component.

The term “position” is used generally herein to mean position or orientation of the moveable component relative to a static component or relative to a particular axis. For example, the term position is used generally herein to mean a position of the moveable component along a primary axis, as well as rotation or tilting of the moveable component about secondary axes, where the secondary axes are perpendicular to the primary axis and orthogonal to each other. The term “position” is used interchangeably herein with the terms “orientation”, “rotation”, and “tilt”.

FIG. 8 shows a schematic block diagram of an actuator 100 comprising a moveable component 102 and a static component 104. The moveable component 102 is moveable relative to the static component 104. The actuator 100 may comprise a plurality of shape memory alloy (SMA) actuator wires arranged to move the moveable component 102 relative to the static component 104. Each actuator wire is coupled to the moveable component 102 and the static component 104. As the length of SMA actuator wires varies with temperature, a change in the length of an SMA actuator wire may result in a change in position and/or orientation of the moveable component 102 relative to the static component.

In embodiments, the actuator 100 may comprise a first SMA actuator wire 106 and a second SMA actuator wire 108. The first SMA actuator wire 106 may have a first portion coupled to the moveable component 102 and a second portion coupled to the static component 104. Contraction of the first SMA actuator wire 106 (caused by heating the wire) may cause the moveable component 102 to move. The second SMA actuator wire 108 may have a first portion coupled to the moveable component 102 and a second portion coupled to the static component 104. Contraction of the second SMA actuator wire 108 (caused by heating the wire) may cause the moveable component 102 to move. Furthermore, the first and second SMA actuator wires 106, 108 are arranged such that contraction of the first SMA actuator 106 may cause expansion of the second SMA actuator wire 108, and contraction of the second SMA actuator wire 108 may cause expansion of the first SMA actuator wire 106. In other words, the first and second SMA actuator wires 106, 108 are opposing wires as they are arranged such that a tension increase in one causes a tension decrease in the other, which enables movement of the moveable component 102. For example, the moveable component 102 may be arranged to move along a first or primary axis relative to the static component 104. In this example, contraction of the first SMA actuator wire 106 may cause the moveable component 102 to move in one direction relative to the first axis, while contraction of the second SMA actuator wire 108 may cause the moveable component 102 to move in another direction relative to the first axis. The moveable component 102 may be able to rotate or tilt about a secondary axis. The secondary axis may be perpendicular to the primary axis. In embodiments, the moveable component 102 may be able to rotate or tilt about two secondary axes, which may be perpendicular to the primary axis and orthogonal to each other. In this case, the moveable component 102 may have two rotation degrees of freedom about the secondary axes.

Actuator 100 comprises at least one sensor 110 for sensing a position and/or orientation of the moveable component 102 relative to the static component 104. Any suitable sensor(s) 110 may be used to sense the position/orientation of the moveable component 102. The or each sensor 110 may be able to directly sense the position/orientation of the moveable component 102 relative to the static component 104. Additionally or alternatively, the or each sensor 110 may indirectly sense or measure the position/orientation of the moveable component 102 relative to the static component 104. For example, measuring resistance of an SMA actuator wire indicates the length of the wire, and the length of the wire can be used to determine the position of the moveable component.

In embodiments, the actuator 100 may comprise at least one resistance measurement circuit 120 for measuring a resistance of the first SMA actuator wire 106 and the second SMA actuator wire 108 to determine a position or orientation of the moveable component 102 relative to the static component 104. In embodiments, a single resistance measurement circuit 120 may be able to measure resistance of each SMA actuator wire. In embodiments, dedicated resistance measurement circuits 120 may be provided to measure the resistance of each SMA actuator wire.

The at least one sensor 110 may comprise at least one Hall effect sensor. A Hall effect sensor is a transducer that varies its output voltage in response to a magnetic field. A Hall effect sensor may comprise a thin strip of metal to which a current may be applied. In the presence of a magnetic field, electrons in the metal strip are deflected toward one edge of the strip, producing a voltage gradient across the width of the strip. In embodiments, the at least one sensor 110 may further comprise at least one magnetic field source for use with the Hall effect sensor(s). A single magnetic field source may be provided for each Hall effect sensor. Alternatively, a separate, dedicated magnetic field source may be provided for each Hall effect sensor. The at least one magnetic field source may be a permanent magnet. In embodiments, the at least one magnetic field source may not be part of the sensor 110 itself but may be provided as a separate component of the actuator 100. Thus, in embodiments, the actuator 100 may comprise at least one magnetic field source 122, which may be provided on, for example, a surface of the moveable component 102 or a surface of the static component 104.

In embodiments, the at least one sensor 110 may comprise three Hall effect sensors and three corresponding magnetic field sources arranged to sense the position or orientation of the moveable component relative to the static component in three-dimensions. This is described in more detail below with reference to FIGS. 2A and 2B.

The at least one sensor 110 may comprise a further Hall effect sensor for compensating for the effect of external magnetic fields, which does not have a corresponding magnetic field source. The further Hall effect sensor may be used to compensate for the effect of external magnetic fields (i.e. magnetic fields not provided by the magnetic field source(s) of the sensor 110/actuator 100). This is described in more detail below with reference to FIGS. 4A and 4B.

The at least one sensor 110 may comprise at least one magnetic tunnel junction (MTJ). Magnetic tunnel junctions exhibit tunnel magnetoresistance and may be used as sensors. An MTJ generally comprises two ferromagnetic layers separated by a thin insulating layer (e.g. a magnesium oxide layer). If the insulating layer is thin enough (e.g. a few nanometres), electrons can tunnel from one ferromagnetic layer into the other. An MTJ device exhibits two stable resistive states depending on whether the magnetisation of the two ferromagnetic layers are in the same direction (parallel) or in opposite directions (anti-parallel). The resistance of the MTJ device is higher in the anti-parallel state than in the parallel state. One of the ferromagnetic layers may be ‘pinned’ such that its magnetisation direction is fixed in a particular direction, while the magnetisation of the other ferromagnetic layer (‘free’ layer) may be manipulated.

In embodiments of the present techniques, at least one MTJ may be used to control the position/orientation of the moveable component 102. The resistance of the at least one MTJ sensor may follow a sinusoidal pattern: the resistance may be approximately constant when the magnetic fields are aligned to within approximately 10 degrees, but as fields become less aligned, the resistance of the at least one MTJ sensor may start to change. A peak rate of change may be observed when the magnetisation vectors are at substantially right angles to each other. This property may be utilised to enable the at least one MTJ to provide information on the position/orientation of the moveable component 102. The at least one MTJ sensor may be configured to sense the greatest rate of change of resistance. This may be achieved by providing the at least one MTJ on the static component 104 and rotating a permanent magnet above (or in the vicinity of) the or each MTJ, such that the magnetic field of the permanent magnet is at 90 degrees to the pinned direction of the MTJ when the moveable component 102 is in a neutral (non-tilted) position. The permanent magnet may be provided on the moveable component 102, above the location of the MTJ on the static component 104. Thus, any changes in position/orientation of the moveable component 102 may cause the magnetic field direction of the permanent magnet to change relative to the direction of the magnetic field when the moveable component is in a neutral/start position, and this change may be sensed by the MTJ.

In embodiments, the at least one sensor 110 may comprise at least one quadrupole magnet (or Q-magnet) provided on the moveable component 102 and arranged to generate a magnetic field, and at least one Hall effect sensor or MTJ provided on the static component 104. FIG. 11 is a schematic diagram of an example quadrupole magnet. The quadrupole magnet comprises four identical magnets 400 (e.g. bar magnets) that are arranged in a ‘cross’ shape, with two magnets arranged such that their north poles are facing each other, and two magnets arranged such that their south poles are facing each other. The dashed arrows represent magnetic field lines between the magnets 400. It will be understood that the magnitude of the magnetic field increases with distance from the centre of the quadrupole, i.e. the field is stronger near the edges of the quadrupole and is approximately zero at the centre of the quadrupole. The quadrupole magnet may be provided on the moveable component 102. The at least one Hall effect sensor or MTJ provided on the static component 104 may be able to detect changes in the position/orientation of the moveable component 102 because as the moveable component 102 moves, the magnetic field strength and direction sensed by the Hall effect sensor or MTJ will change.

In some cases, the effect of external magnetic fields (i.e. magnetic fields not provided by the magnetic field source(s) of the actuator 100), may be large enough to deflect the ‘neutral’ or zero flux/field point of the quadrupole magnet away from the centre of the quadrupole. In this case, calibration of the actuator 100 may be required to determine the new ‘neutral’ position, so that data from the quadrupole magnet may be reliably used to determine position/orientation of the moveable component 102.

The actuator 100 may comprise a control module 112. The control module 112 may be configured to receive data from the at least one sensor 110 and optionally from the at least one resistance measurement circuit 120. The control module 112 may be configured to generate control signals to control power delivered to the first SMA actuator wire 106 and the second SMA actuator wire 108 based on the received data, to thereby adjust the position of the moveable component 102 relative to the static component 104. Actuator 100 may comprise a power delivery module 114, which may be configured to receive control signals from the control module 112, and deliver power, based on the received control signals, to the SMA actuator wires 106, 108.

The control module 112 may comprise hardware and/or software elements. For example, control module 112 may comprise a processor and processor control code, and/or may comprise control circuitry to implement any of the methods described herein. The control module 112 may be in a communicative relationship with at least the sensor(s) 110 of actuator 100. The control module 112 may receive data from the at least one sensor 110 and optionally, may receive additional data from the at least one resistance measurement circuit 120. The control module 112 may generate control signals to control power delivered by power delivery module 114 to the first SMA actuator wire 106 and the second SMA actuator wire 108 based on the received data (and optionally the additional data), to adjust the position of the moveable component 102 relative to the static component 104. The control module 112 may therefore be in a communicative relationship with the power delivery module 114.

The control module 112 may be configured to receive a required position for the moveable component 102, and generate a first control signal to cause the moveable component 102 to move to the required position.

In embodiments, following application of the first control signal, the control module 112 may be configured to: receive data from the at least one sensor 110 (and optionally from the at least one resistance measurement circuit), indicating a current position of the moveable component 102 relative to the static component 104, determine whether the sensed position matches the received required position, and generate, if the sensed position does not match the received required position, a second control signal to adjust the current position of the moveable component 102 towards the required position.

The actuator 100 may comprise storage 116 for storing at least one look up table (LUT) 118. The look up table 118 may show/store a plurality of positions of the moveable component 102 and, for each position, at least one associated sensor value. In other words, the look up table 118 may store, for each possible position, a map between a position of the moveable component 102 and at least one sensor value when the moveable component 102 is in that position. The look up table 118 may be populated using data collected during one or more of: an actuator manufacturing process, a calibration process, and an initialisation process performed every time, or every nth time, the actuator 100 is initialised. Updating the LUT 118 during an initialisation process may be useful because the performance or characteristics of the SMA actuator wires 106, 108 may change with use/actuator lifetime.

In some cases, the strength of external magnetic fields may be strong enough to disturb or otherwise impact the normal operation of actuator 100. Thus, in embodiments, the LUT(s) 118 may comprise data indicating a strength of any external magnetic field(s). This may be determined during calibration of the actuator 100 in situ (e.g. when it is within an apparatus/end-user device). This may enable the strength of the external magnetic field(s) to be compensated for when the at least one sensor comprises a Hall sensor, quadrupole magnet or MTJ. The data on the external magnetic field in look up table 118 may be modifiable using data collected from the at least one sensor during use of the actuator 100.

The moveable component 102 of actuator 100 may be moveable along a first axis relative to the static component 104. The at least one sensor 110 may sense a position of the moveable component 102 along the first axis.

The moveable component 102 may have one rotational degree of freedom about a second axis that is perpendicular to the first axis. In embodiments, the moveable component 102 may be able to rotate or tilt about two secondary axes that may be perpendicular to the first axis and orthogonal to each other. In this case, the moveable component 102 may have two rotational degrees of freedom about the secondary axes. The at least one sensor 110 may be able to sense rotation or tilting of the moveable component about the second axis (or secondary axes). Thus, the at least one sensor 110 may be able to sense/detect tilting of the moveable component 102.

In embodiments, the moveable component 102 may be moveable along a first axis relative to the static component, and the at least one sensor 110 and/or the at least one resistance measurement circuit 120 may indicate a position of the moveable component 102 along the first axis. In some cases, the moveable component 102 may have at least one rotational degree of freedom about secondary axes that are perpendicular to the first axis, (and orthogonal to each other) and the at least one sensor 110 and/or the at least one resistance measurement circuit 120 may provide information indicating the rotation or tilt of the moveable component 102 about the secondary axes.

In embodiments, the at least one sensor 110 may comprise three sensors arranged to indicate rotation or tilt of the moveable component 102 in two rotational degrees of freedom about the second axes.

In a particular embodiment, the moveable component 102 may be moveable along a first axis relative to the static component 104 and has two rotational degrees of freedom about second axes that are perpendicular to the first axis (and orthogonal to each other). In this case, the actuator 100 may comprise: at least one resistance measurement circuit 120 for measuring a resistance of the first SMA actuator wire 106 and the second SMA actuator wire 108 to determine a position or orientation of the moveable component 102 relative to the static component 104. The at least one sensor 110 of the actuator 100 may comprise at least three Hall effect sensors to sense one or both of: position of the moveable component 102 along the first axis, and rotation or tilting of the moveable component 102 about the second axes. This arrangement of sensors 110 may enable the position and orientation (e.g. tilt) of the moveable component 102 to be determined relative to the static component 104 in three dimensions.

There are many types of apparatus in which it is desirable to provide positional control of a moveable element. The actuator 100 may be used to, for example, move at least one optical element of an image capture device. Movement of the moveable component 102 may provide auto-focussing and/or optical image stabilisation for the image capture device.

The actuator 100 may comprise a further two SMA actuator wires. The first and second SMA actuator wires 106, 108 may form a first pair of opposing wires, and the further two SMA actuator wires may form a second pair of opposing wires. The actuator 100 may comprise a total of eight SMA actuator wires.

FIG. 9 shows a schematic block diagram of an apparatus 200 comprising an actuator, such as actuator 100 described above. Actuator 100 may be arranged to move one or more components of apparatus 200. Such components may be coupled to the moveable component 102 of the actuator 100 to enable the actuator to control their position/orientation.

Apparatus 200 may comprise an actuator 100 for moving a component (not shown) of the apparatus 200. The actuator 100 may comprise: a moveable component 102 and a static component 104, where the moveable component 102 is moveable relative to the static component 104; a first shape memory alloy (SMA) actuator wire 106 having a first portion coupled to the moveable component 102 and a second portion coupled to the static component 104, wherein contraction of the first SMA actuator wire causes the moveable component to move; a second shape memory alloy (SMA) actuator wire 108 having a first portion coupled to the moveable component 102 and a second portion coupled to the static component 104, wherein contraction of the second SMA actuator wire 108 causes the moveable component 102 to move, and wherein contraction of the first SMA actuator wire 106 causes expansion of the second SMA actuator wire 108 and contraction of the second SMA actuator wire 108 causes expansion of the first SMA actuator wire 106; and at least one sensor 110 for sensing a position or orientation of the moveable component 102 relative to the static component 104.

The apparatus 200 may comprise a power source or power delivery module 204. The power source 204 may be a dedicated power source for the actuator 100, or may be a power source shared by multiple power-consuming components of apparatus 200. The apparatus 200 may comprise a control module 202. The control module 202 may be a dedicated control module for the actuator 100, or may be a control module shared by multiple components of apparatus 200. The control module 202 may comprise hardware and/or software elements. For example, control module 202 may comprise a processor and processor control code, and/or may comprise control circuitry to implement any of the methods described herein. The control module 202 may be in a communicative relationship with the actuator 100. The control module 202 may receive data from the at least one sensor 110. The control module 202 may generate control signals to control power delivered from the power source 204 to the first SMA actuator wire 106 and the second SMA actuator wire 108 based on the received data, to adjust the position of the moveable component 102 relative to the static component 104. The control module 202 may therefore by in a communicative relationship with the power delivery module 204.

The apparatus 200 may comprise storage 206 for storing at least one look up table (LUT) 208. The look up table 208 may show/store a plurality of positions of the moveable component 102 and, for each position, at least one associated sensor value. In other words, the look up table 208 may store, for each possible position, a map between a position of the moveable component 102 and at least one sensor value when the moveable component 102 is in that position. The look up table 208 may be populated using data collected during one or more of: an actuator manufacturing process, a calibration process, and an initialisation process performed every time, or every nth time, the actuator 100 is initialised. Updating the LUT 208 during an initialisation process may be useful because the performance or characteristics of the SMA actuator wires 106, 108 may change with use/actuator lifetime.

The apparatus 200 may comprise at least one resistance measurement circuit 120 for measuring a resistance of the first SMA actuator wire 106 and the second SMA actuator wire 108 of the actuator 100 to determine a position or orientation of the moveable component 102 relative to the static component 104. In embodiments, a single resistance measurement circuit 120 may be able to measure resistance of each SMA actuator wire. In embodiments, dedicated resistance measurement circuits 120 may be provided to measure the resistance of each SMA actuator wire.

The apparatus 200 may be any device comprising at least one moveable component. In particular embodiments, actuator 100 may be used to move an optical element of an image capture device in apparatus 200. Thus, in embodiments, the apparatus 200 may be any one of: a smartphone, a mobile computing device, a laptop, a tablet computing device, a security system, a gaming system, an augmented reality system, an augmented reality device, a wearable device, a drone, a vehicle, and an autonomous vehicle.

In a related approach of the present techniques, actuator 100 may be used in (incorporated into) any one or more of: a smartphone, a mobile computing device, a laptop, a tablet computing device, a security system, a gaming system, an augmented reality system, an augmented reality device, a wearable device, a drone, a vehicle, and an autonomous vehicle.

FIG. 10 shows a flowchart of example steps to control position and/or orientation of a moveable component of an actuator. The control may be performed by a control module 112, 202.

The method may begin when the control module 112, 202 receives a required position for a moveable component 102 of the actuator 100 (step S300). Optionally, the control module 112, 202 may receive temperature data indicating the temperature in the vicinity of the SMA actuator wires (step S302), as temperature affects the length of the SMA actuator wires and this may be useful in determining the precise position of the moveable component 102.

Broadly speaking, the method may comprise receiving data from at least one sensor 110, and generating control signals to control power delivered to the first SMA actuator wire 106 and the second SMA actuator wire 108 based on the sensor data, to adjust the position of the moveable component 102 relative to the static component 104.

In embodiments, the method may comprise: receiving (at the control module 112, 202) a required position for the moveable component 102; and generating a first control signal to cause the moveable component 102 to move to the required position (step S304). Optionally, the method may comprise controlling the power delivery to the SMA actuator wires (step S306). Alternatively, the control signal may be transmitted to a power delivery module/power source, which interprets the control signal and determines how to deliver the required power to each SMA actuator wire.

Following application of the first control signal, the method may comprises: receiving data from the at least one sensor 110 indicating a current position of the moveable component 102 relative to the static component 104 (step S308).

At step S310, the method may comprise determining whether the sensed position substantially matches (i.e. within some permitted tolerance/error) the received required position. If the sensed position substantially matches the received required position, the method may return to step S300. The control module may await further instructions regarding the position/orientation of the moveable component. If the sensed position does not match the received required position (target position), the method may comprise generating a second control signal to adjust the current position of the moveable component 102 towards the required position (step S312). The method may return to step S308.

In embodiments, the step (S310) of determining whether the sensed position matches the received required position may comprise: retrieving at least one sensor value associated with the required position, from a look up table storing a plurality of positions of the moveable component 102 and, for each position, at least one associated sensor value; and determining whether the received data from the at least one sensor matches the retrieved at least one sensor value.

Particular example actuator arrangements are now described with reference to FIGS. 1 to 7. While the following examples refer to actuators for moving optical elements in image capture devices (such as cameras), it will be understood by a person skilled in the art that these are merely illustrative, non-limiting examples. The techniques described herein may be applied to move any moveable element of an electromechanical apparatus.

An example actuator may comprise a movable element that may be moved relative to a support structure, and a plurality of SMA actuator wires that connect the movable element to the support structure and may enable movement in one or more degrees of freedom.

Example actuators are described in international patent publication numbers WO2011/104518, WO2012/066285, WO2014/076463, and WO 2017/098249 which disclose SMA actuators comprising eight SMA wires connecting a movable element to a support structure in a plurality of configurations. The arrangement of the SMA wires and the support structure allows movement of the movable element in six degrees of freedom (DOF), three translational DOF and three rotational (tilt) DOF. In embodiments where the movable element is a camera lens element suspended over an image sensor in a camera assembly, the SMA actuator may be used can adjust the camera focus on an image sensor for autofocus (AF) applications and additionally provide optical image stabilisation (OIS).

Further examples of actuators are described in: international patent publication number WO2007/113478 where at least one pair of SMA actuator wires is used to move a camera lens element in one translational DOF in the direction parallel to the optical axis to adjust the camera focus; international patent publication numbers WO2010/029316, WO2010/089529 and WO2011/104518 which disclose SMA wire actuators to provide OIS by driving tilting of a camera lens element in two rotational DOF perpendicular to the optical axis; international patent publication numbers WO2013/175197 and WO2014/083318 which disclose SMA wire actuators to provide OIS by moving a lens element in two translational DOF that are perpendicular to each other and to the optical axis.

As mentioned above, the length of a wire formed of SMA material varies with temperature. This effect can be used for actuation as described in detail in the above-mentioned published patent applications. The electrical resistance of SMA actuator wires is roughly proportional to their length. Therefore, the length of the SMA actuator wires may be measured in real-time by driving an electrical current through them and using it to measure their electrical resistance. A control system with an electrical circuit, which includes a drive part and a resistance measurement sense part, may be used to drive electrical power through the SMA actuator wires and provide closed loop control. The desired translational and rotational position of the lens element may be achieved by measuring the resistance of each SMA actuator wire and setting target resistance values for each wire that correspond to the desired positions of the lens element.

Broadly speaking, embodiments of the present techniques build upon the above-mentioned actuators by the addition of position sensors to determine the position and/or orientation of a moveable component of an actuator with respect to a static component of the actuator. The term “position sensor” used herein is used to mean any sensor that may enable direct or indirect sensing/measurement of the position and/or orientation of a moveable component of an actuator, as explained earlier. In embodiments, resistance of the SMA actuator wires may be measured to extrapolate the position/orientation of the moveable component. Additionally or alternatively, sensors may be used to provide additional data indicative of the position of the moveable component relative to the static component (e.g. a support structure) of the actuator. The sensor data may be used to provide increased accuracy to the determined position/orientation of the moveable component, increased speed in determining the translational and rotational position of the lens element, or a combination of improved accuracy and speed. One example sensor is a Hall-effect sensor, as described above.

FIG. 1A shows a perspective view of two sides of a device comprising an actuator, and FIG. 1B shows a perspective view of two other sides of the device. FIGS. 1A and 1B show an embodiment of a camera assembly that may comprises eight SMA actuator wires 1-8 connecting a moveable element (e.g. a lens element) to a support structure (static component). This arrangement may provide camera auto-focus (AF) and optical image stabilisation (OIS). The SMA wires 1-8 may be connected to lens element 10 and to support structure arms 9 using any suitable method. For example, the SMA wires 1-8 may be coupled using crimps to provide a mechanical and electrical connection. Two SMA wires are connected to each of the four side faces of the lens element. FIGS. 1A and 1B show a possible arrangement of the 8 SMA wires. Other arrangements of the 8 SMA wires are possible as detailed in international patent publication numbers WO2011/104518, WO2012/066285, WO2014/076463, and WO2017/098249.

FIG. 2A is a perspective view of the device of FIG. 1A showing the position of a first and a second Hall effect sensor, and FIG. 2B is a perspective view of the device of FIG. 1B showing the position of a third Hall effect sensor. The Hall-effect sensors 12-14 may be arranged symmetrically on support structure base 11, such that they are located adjacent to three permanent magnets provided on the lens element 10. The permanent magnets are not shown in FIGS. 2A and 2B for clarity.

FIG. 3A is a side view of the device of FIG. 1A showing the position of a first and a second Hall effect sensor and a first and a second magnet, and FIG. 3B is a side view of the device of FIG. 1B showing the position of a third Hall effect sensor and a third magnet. Permanent magnets 16-18 are provided on the lens element 10, adjacent to three Hall-effect sensors 12-14 provided on the support structure base 11, as shown. Thus, each Hall effect sensor 12, 13, 14 has a dedicated magnetic field source 16, 17, 18, as shown in FIGS. 3A and 3B.

The x,y,z coordinate system shown is the same in FIGS. 1 to 7 and is defined relative to the support structure 11. The coordinate system is orientated so that an imaginary straight line that intercepts sensors 12 and 13 lies in the direction of the y-axis, an imaginary straight line connecting the sensors 13 and 14 lies in the direction of the x-axis, and the z-axis is along the direction perpendicular to the plane that intersects all three sensors.

FIGS. 2A to 3B show an example arrangement of Hall effect sensors and magnetic field sources (e.g. permanent magnets). Other arrangements are possible, and the depicted arrangement is provided as a non-limiting example. For example, it may be possible to place all three Hall effect sensors on three of the support structure arms 9, or to place two sensors on the support structure arms 9 and one sensor on the support structure base 11, or vice versa.

With reference to FIGS. 1A to 3B, an image sensor (not shown) may be located symmetrically in the middle of the support structure base 11 at a specific, predefined distance below the lens element 10. The z direction of the coordinate system shown in FIGS. 1 to 7 is in a direction perpendicular to the plane of the image sensor. The lens element 10 may comprise one or more lenses whose optical axes lie parallel to the z direction. A control system (e.g. control module described above) may be able to adjust the position of the lens element 10, in order to e.g. adjust camera focus, by targeting pre-determined values of SMA wire resistance that are known to correspond to specific positions of the lens element in the z direction. The position in the z direction may be varied by varying the length of the SMA wires. As an example, in the arrangement shown in FIGS. 1A to 3B, movement in the positive z direction may be performed by increasing the length of four SMA wires 3,4,7,8 (by decreasing their temperature) and decreasing the length of four SMA wires 1,2,5,6 (by increasing their temperature). The opposite operation will result in movement in the negative z direction. For auto-focus (AF), the location of the lens element may be varied until the desired focus is achieved.

Hall effect sensor measurements may be used in addition to, or instead of, SMA actuator wire measurements. The translational position of the lens element in the z axis direction may be detected by measuring the change in the Hall effect sensor values relative to Hall effect sensor values measured when the lens element 10 is in an initial (start) position. The initial position of the lens element may be determined during manufacture or during a start-up procedure performed after every initialisation of the SMA wire actuator, as described above. For a displacement of the lens element along the z axis direction, all three Hall-effect sensors may measure roughly the same difference in distance from the initial position. Therefore, a control system may target a Hall-effect sensor value that corresponds to the desired translational position along the z axis. The target sensor value may correspond to values of only one of the Hall-effect sensors, or to average values of two Hall effect sensors, or to a combination of all three sensor values. The length of time required to achieve the desired focus may be 15 ms or less.

Optical image stabilisation (OIS) may be performed by shifting the lens element 10 along the x-y plane parallel to the x and y axes and perpendicular to the optical axis. Shake or vibration of the camera assembly will degrade the quality of the images captured by the image sensor. The purpose of OIS is to compensate for the shake of the camera assembly by shifting the lens element along the x-y plane perpendicular to the optical axis. The use of eight SMA actuator wires for OIS is described in international patent publication numbers WO2011/104518, WO2012/066285, WO2014/076463, and WO2017/098249.

Referring to FIGS. 1A and 1B, a pure shift along the positive y axis may be performed by increasing the length of SMA wires 3 and 8 and by decreasing the length of SMA wires 4 and 7. A pure shift along the positive x axis may be performed by increasing the length of SMA wires 1 and 5 and decreasing the length of SMA wires 2 and 6. The opposite operations may be used to shift the lens element 10 along the negative y and x axes. Combinations of these operations may be used to shift the lens element 10 along any axis in the x-y plane. For pure shifts of the lens element in the x-y plane, all three Hall effect sensors may measure roughly the same difference in distance from an initial position. Therefore, the sensor values may be used to provide OIS functions for a fixed focus camera application, and/or to provide OIS and AF functions simultaneously. When the position of the lens element 10 along the z axis is constant, the Hall effect sensor values may correspond to a position purely in the x-y plane, corresponding to an OIS function in a fixed focus camera. When translations along the z axis are desirable, for example when AF is desirable in addition to OIS, the Hall effect sensor values may account for the increased distance of the lens element from the initial position due to translation along the z axis in addition to translation in the x-y plane. Therefore, for combined AF and OIS, the control system may target a Hall effect sensor value that corresponds to the desired translational position along the z axis and along the x-y plane. The target sensor value may correspond to measures of only one of the Hall-effect sensors or to average measures of two or of all three sensors combined. In addition to the Hall effect sensor measures, electrical resistance values of all eight SMA actuator wires may be needed to fully define the position of the lens element 10 in all three translational degrees of freedom.

Tilt about the x and y axes will cause the optical axis to no longer be parallel to the z axis. This will cause the depth of focus to be non-uniform across the image sensor which is undesirable.

With reference to FIGS. 2A and 2B, tilt of the lens element 10 about the x and y axes may be detected by monitoring the difference in the values measured by three Hall-effect sensors 12, 13 and 14. For example, for pure tilt about the positive y axis, sensors 12 and 13 may output almost equal values that decrease with increasing angle of tilt. Sensor 14 may output a different value that may increase with increasing angle of tilt. The difference between the output of sensor 14 and the outputs of sensors 12 and 13 may be used to calculate the angle of tilt (tilt angle). As another example, for pure tilt around the positive x axis, sensors 13 and 14 may output equal values that are different from the values of sensor 12. In addition, tilt about any axis in the x-y plane may be determined by superposition of the pure tilt about the x and y axes (e.g. by comparing the difference in the measurements from all three Hall-effect sensors). Therefore, the control system may target values of the difference between the measures of the three Hall-effect sensors that correspond to the desired tilt position around the x and y axes.

In the above embodiment, it will be understood that for all AF, OIS and tilt measurement operations, the Hall-effect sensor values may be used concurrently with resistance measurements of the eight SMA actuator wires. The Hall-effect sensor values may be calibrated to provide distance measurements between the location of the three sensors on the support structure base 11 and their corresponding permanent magnet on the lens element 10. The calibration may be performed during manufacture within specified tolerance limits to achieve the required accuracy.

The control system may set target SMA wire resistance values for all wires and target position sensor values that correspond to the desired position of the lens element. The position sensors may be used to increase the accuracy of the lens element position, or to decrease the length of time required to achieve the desired position, or a combination of both. Closed-loop feedback control may be performed using the target SMA wire resistance values and the target position sensor values together with the real-time SMA wire resistance measures and the real-time position sensor measures to set the electrical drive power through the SMA wires in real-time. The target values of SMA wire resistance values and position sensor values set by the control system can be extracted from a look-up table of pre-determined calibrated values stored inside the memory of the control system. These pre-determined values can be determined during manufacture or during a start-up procedure performed after every initialisation of the SMA actuator or a combination of both.

Camera assemblies may be required to operate, for example in smartphone devices, in close proximity to Voice Coil Motors (VCM) or speakers that emit magnetic fields which can interfere with the position sensor measures. FIG. 4A is a perspective view of the device of FIG. 1B showing the position of a third and a fourth Hall effect sensor, and FIG. 4B is a side view of the device of FIG. 4A showing the position of a third and a fourth Hall effect sensor and a third magnet. In this embodiment, an additional Hall effect sensor 15 is provided without an associated permanent magnet. This may enable compensation to be made for external magnetic fields. The additional Hall effect sensor 15 may be placed at a location on the support structure base 11 that is sufficiently far away from the other permanent magnets on the lens element 10 to minimise the effects of their magnetic fields on sensor 15.

The Hall effect sensor 15 may be calibrated during manufacture against the magnitude of the magnetic fields produced by the three permanent magnets in the lens element to provide the baseline magnetic field readings with the lens element located at various positions along the three axes x, y and z. By subtracting these known readings from the measures of sensor 15 during service, the presence of external magnetic fields can be detected with greater accuracy. The external magnetic fields can therefore be subtracted from the measures of the Hall-effect sensors 12-14 in real-time to limit their interference.

FIG. 5 is a schematic diagram of an example arrangement of magnets relative to Hall effect sensors. Here, only the sensing face of the sensors is shown. The sensing face of the sensors is substantially flat and is preferentially arranged to lie on the x-y plane. The permanent magnets are preferentially arranged in a direction where an imaginary straight line that crosses their north and south poles is parallel to the z axis and perpendicular to the sensing face of the sensors. The magnetic field is represented schematically by the magnetic field lines 20 with direction from the north to the south pole of the magnets shown by arrows 21. Reversing the polarity of the permanent magnets reverses the direction of the magnetic field lines and reverses the sign of the readings produced by the sensors. Therefore, the polarity of the magnets can be as shown in FIG. 5 or in the opposite direction. The control system calibrated to account for the as-installed polarity of the magnets.

The Hall-effect sensors can sense the magnitude of the component of the magnetic field perpendicular to their sensing face only. The Hall-effect sensor readings vary as the magnitude of the magnetic field crossing the sensing face of the sensors varies. This occurs when the distance between the magnet and the sensor varies and when the angle of tilt between the magnet and the sensor varies. The distance between the magnets and the sensors varies when the lens element translates along the x, y and z axes. The closer the magnets are to the sensors, the larger the sensor readings are. The angle of tilt between the magnets and the sensors varies as the lens element tilts relative to the support structure around the x and y axes. The sensor readings are largest when the magnets are orientated perpendicularly to the x-y plane.

FIG. 6 is a perspective view of an device comprising an optical image stabilisation (OIS) actuator. FIG. 7A is a perspective view of the device of FIG. 6 showing an example arrangement of Hall effect sensors and magnets, and FIG. 7B is a perspective view of the device of FIG. 6 showing another example arrangement of Hall effect sensors and magnets. The OIS actuator may comprise a moving plate 22 and a base plate 23. The moving plate may comprise four SMA wires 24 to 27 for moving the moving plate in two translational degrees of freedom along the x-y plane. The optical axis is along the direction perpendicular to the x-y plane. A pure shift along the positive x axis may occur by decreasing the length of SMA wires 24 and 25. A pure shift along the positive y axis may occur by decreasing the length of SMA wires 25 and 27. Performing the opposite operations may shift the moving plate along the negative x and y axes, respectively.

FIG. 7A shows an example arrangement in which Hall sensors 28 and 29 are on the base plate, and magnets 30 and 31 are on the moving plate 22. In another embodiment, the magnets and sensors may be arranged diagonally and symmetrically on the actuator along the y axis. In the depicted arrangement, the magnets and sensors are arranged diagonally and symmetrically on the actuator along the x axis. The position of the moving plate along the x and y axes may be determined using the absolute measurements of the Hall sensors and the difference in the measurements between the two sensors. Positions that lie purely on the y axis may produce sensor values that are almost identical. However, it will not be possible to distinguish between positions on the +y axis and the −y axis. For shifts along the +x axis the measurements of sensor 29 may be increasing and the measurements of sensor 28 may be decreasing. The opposite may occur for shifts along the −x axis. Combinations of these measurements may be used to detect the position of the moving plate on the x-y plane.

FIG. 7B shows an arrangement of an OIS actuator that includes an additional magnet 33 and an additional Hall sensor 32. The additional magnet and sensor enable the ability to distinguish whether the moving plate 22 is located on the +y axis or on the −y axis. For shifts along the +y axis, the measurements in sensor 32 may be decreasing. For shifts along the −y axis the measurements in sensor 32 may be increasing.

Further embodiments of the present techniques are set out in the following numbered clauses:

1. An SMA actuator comprising of: a moving portion and a static portion, wherein one or more SMA wires which are connected between the static portion and the moving portion in such a manner that when one SMA wire is heated, the contraction of the wire causes the moving portion to move with respect to the static portion, a position sensor that measures the position of one part of the moving portion in such a manner that the reading from the position sensor changes when the actuator moves in at least one degree of freedom, a resistance measurement circuit that measures the resistance of one or more SMA wires, a control circuit that delivers power to the SMA wires depending on the measured position and the measured resistance.

2. The device according to clause 1 where the position sensor is a Hall sensor.

3. The device according to clause 1 or 2 where the actuator is used to move an optical element (such as a lens, image sensor, mirror, prism) in a camera.

4. The device according to clause 1, 2 or 3 where the moving portion consists of one or more lens elements.

5. The device according to clause 3 or 4 where the position sensor predominantly measures motion in a direction parallel to the optical axis of the optical element

6. The device according to any of the preceding clauses that contains 3 position sensors.

7. The device according to clause 6 and 3, 4 or 5 where the position sensors are oriented to allow the difference in the readings of the position sensors to be a measure of rotation of the moving portion about an axis that is perpendicular to the optical axis.

8. The device according to clause 3 or 4 where position sensors are used to measure the position of the optical element parallel to the optical axis relative to the static portion.

9. The device according to clause 8 where position sensors are used for camera auto focus measurement.

10. The device according to clause 3 where three position sensors are used to measure the tilt of the optical element in two rotation degrees of freedom perpendicular to the optical axis.

11. The device according to all preceding clauses where electrical resistance measurement of SMA wires is used in conjunction with three position sensors to compensate for changes in sensor output due to translation perpendicular to the optical axis and rotation around the optical axis.

12. The device according to all preceding clauses that includes a control system where the control system is using a look-up table, stored in memory, populated with target values of position sensor measures for optical element positions in three degrees of freedom and associated target values of SMA wire resistance measures for optical element positions in six degrees of freedom to be used in tandem in closed-loop control. The position sensor measures relate to optical element positions in one translation degree of freedom parallel to the optical axis and two rotation degrees of freedom perpendicular to the optical axis. The SMA wire resistance measures relate to optical element positions in three translation degrees of freedom and three rotation degrees of freedom.

13. The device according to clause 12 where the look-up table of the control system is populated with values determined during manufacture or during a start-up procedure performed after every initialisation of the SMA actuator or a combination of both.

14. The device according to clauses 12 and 13 where proximity sensor measures are used in addition to SMA wire resistance measures to increase the accuracy of the optical element position or to decrease the length of time required to achieve the desired position or a combination of both.

15. The device according to clause 1 where the moving portion is a camera optical element.

16. The device according to all preceding clauses where an additional Hall sensor is used to calibrate against external magnetic fields.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1. An actuator comprising:
a moveable component and a static component, where the moveable component is moveable relative to the static component;
a first shape memory alloy (SMA) actuator wire having a first portion coupled to the moveable component and a second portion coupled to the static component, wherein contraction of the first SMA actuator wire causes the moveable component to move;
a second shape memory alloy (SMA) actuator wire having a first portion coupled to the moveable component and a second portion coupled to the static component, wherein contraction of the second SMA actuator wire causes the moveable component to move, and wherein contraction of the first SMA actuator wire causes expansion of the second SMA actuator wire and contraction of the second SMA actuator wire causes expansion of the first SMA actuator wire; and
at least one sensor for sensing a position or orientation of the moveable component relative to the static component.

2. The actuator as claimed in claim 1 further comprising at least one resistance measurement circuit for measuring a resistance of the first SMA actuator wire and the second SMA actuator wire to determine a position or orientation of the moveable component relative to the static component.

3. The actuator as claimed in claim 1 where the at least one sensor comprises at least one magnetic sensor.

4. The actuator as claimed in claim 3 further comprising at least one magnetic field source.

5. (canceled)

6. The actuator as claimed in claim 4 where the at least one sensor comprises three magnetic sensors arranged to sense the position or orientation of the moveable component relative to the static component in three-dimensions.

7. The actuator as claimed in claimed in claim 6 where the at least one sensor comprises a further magnetic sensor for compensating for the effect of external magnetic fields.

8. The actuator as claimed in claim 3 where the at least one sensor comprises at least one magnetic tunnel junction.

9. The actuator as claimed claim 1 where the at least one sensor comprises a quadrupole magnet and at least one of a: Hall effect sensor or magnetic tunnel junction.

10. The actuator as claimed in claim 1 further comprising:
a control module for:
receiving data from the at least one sensor; and
generating control signals to control power delivered to the first SMA actuator wire and the second SMA actuator wire based on the received data, to adjust the position of the moveable component relative to the static component.

11. The actuator as claimed in claim 10 further comprising at least one resistance measurement circuit for measuring a resistance of the first SMA actuator wire and the second SMA actuator wire to determine a position or orientation of the moveable component relative to the static component and wherein the control module receives additional data from the at least one resistance measurement circuit and generates the control signals using the additional data.

12. (canceled)

13. (canceled)

14. The actuator as claimed in claim 10, further comprising:
storage for storing a look up table of a plurality of positions of the moveable component and, for each position, at least one associated sensor value.

15. (canceled)

16. The actuator as claimed in claim 14 where the look up table is populated using data collected during one or more of: an actuator manufacturing process, a calibration process, and an initialisation process performed whenever the actuator is initialised.

17. The actuator as claimed in claim 14, where the look up table is modified using data collected from the at least one sensor during use of the actuator.

18. The actuator as claimed in claim 1 where the moveable component is moveable along a first axis relative to the static component, and the at least one sensor senses a position of the moveable component along the first axis.

19. The actuator as claimed in claim 18 where the moveable component has a rotational degree of freedom about a second axis that is perpendicular to the first axis, and the at least one sensor senses rotation or tilting of the moveable component about the second axis.

20. The actuator as claimed in claim 2, where the moveable component is moveable along a first axis relative to the static component, and the at least one sensor and/or the at least one resistance measurement circuit indicate a position of the moveable component along the first axis.

21. The actuator as claimed in claim 20 where the moveable component has a rotational degree of freedom about a second axis that is perpendicular to the first axis, and the at least one sensor and/or the at least one resistance measurement circuit indicate rotation or tilting of the moveable component about the second axis.

22. The actuator as claimed in claim 18, where the at least one sensor comprises three sensors arranged to indicate rotation or tilting of the moveable component in two rotational degrees of freedom about secondary axes that are each perpendicular to the first axis.

23. The actuator as claimed in claim 1 where the moveable component is moveable along a first axis relative to the static component and has two rotational degrees of freedom about secondary axes that are perpendicular to the first axis, the actuator further comprising:
at least one resistance measurement circuit for measuring a resistance of the first SMA actuator wire and the second SMA actuator wire to determine a position or orientation of the moveable component relative to the static component; and
the at least one sensor comprises:
at least three Hall effect sensors to sense one or both of: position of the moveable component along the first axis, and rotation or tilting of the moveable component about the secondary axes.

24. The actuator as claimed in claim 1, where the moveable component moves at least one optical element of an image capture device.

25. The actuator as claimed in claim 24 where movement of the moveable component provides auto-focussing for the image capture device.

26. The actuator as claimed in claim 24 where movement of the moveable component provides optical image stabilisation for the image capture device.

27. The actuator as claimed in claim 1 where the actuator comprises a further two SMA actuator wires.

28. The actuator as claimed in claim 1 where the actuator comprises a further six SMA actuator wires.

29-33. (canceled)

34. A method for controlling an actuator, the method comprising:
receiving a required position for a moveable component of the actuator, where the moveable component is moveable relative to a static portion of the actuator by a first shape memory alloy (SMA) actuator wire and by a second shape memory alloy (SMA) actuator wire, wherein contraction of the first SMA actuator wire causes the moveable component to move and expansion of the second SMA actuator wire, and wherein contraction of the second SMA actuator wire causes the moveable component to move and expansion of the first SMA actuator wire;
receiving data from at least one sensor for sensing a current position of the moveable component relative to the static component; and
generating control signals to control power delivered to the first SMA actuator wire and the second SMA actuator wire based on the sensor data, to adjust the position of the moveable component relative to the static component.

35-43. (canceled)

44. The actuator as claimed in claim 3 wherein the at least one sensor comprises at least one Hall effect sensor.

45. The actuator as claimed in claim 1 wherein the at least one sensor does not measure a resistance of the first SMA actuator wire or the second SMA actuator wire.

46. The actuator as claimed in claim 1 wherein the at least one sensor comprises at least two sensors arranged to sense movement of the moveable component relative to the static component in at least two degrees of freedom.
